(19) United States
(12) Patent Application Publication
(10) Pub. No.: US 2011/0125838 A1
(43) Pub. Date: May 26, 2011

(54) SYSTEM FOR AUTOMATED GENERATION AND DEPLOYMENT OF CUSTOMIZED MOBILE APPS FOR MULTIPLE MOBILE DEVICE PLATFORMS

(76) Inventor: BINDU RAMA RAO, Laguna Niguel, CA (US)

(21) Appl. No.: 13/017,024

(22) Filed: Jan. 30, 2011

Related U.S. Application Data
(63) Continuation-in-part of application No. 11/977,763, filed on Oct. 25, 2007.

(51) Int. Cl. G06F 15/16

(52) U.S. Cl. 709/203

(57) ABSTRACT

A system for creating and deploying custom mobile applications, that is easy for even an individual or small enterprise to employ, wherein the system facilitates creation of a mobile application behavior specification by a user that is easily transformed to new custom applications that are easily deployed. It employs, among others items, a mobile client in a mobile device that receives a notification from a server, wherein the notification comprises one of a reference and a link to the a mobile application behavior specification, and, in response, the mobile client retrieves the mobile application behavior specification from the server, processes it, automatically morphs into an associated mobile application and presents itself to a user of the mobile device. The user can enter data in input fields (such as text entry boxes), make selection on multiple choice prompts (inclusive or exclusive set of multiple choices are displayed), provide audio recording, provide digital photo images, record video, and send them to the server for storage associated with that mobile application.

### CROSS REFERENCES TO RELATED APPLICATIONS

The present patent application is a continuation-in-part of, claims priority to, and makes reference to U.S. non-provisional patent application Ser. No. 11/977,763, entitled “MOBILE DEVICE THAT PRESENTS INTERACTIVE MEDIA AND PROCESSES USER RESPONSE”, filed on Oct. 25, 2007, docket number BRR2007Qaire 11-U1. The complete subject matter of the above-referenced United States patent application is hereby incorporated herein by reference, in its entirety.

### BACKGROUND

1. Technical Field

The present invention relates generally to mobile applications, and specifically to the automatic generation and deployment of mobile applications in mobile devices.

2. Related Art

In the last decade, mobile devices of all kinds have proliferated all over the world. Some of them are small tiny cellular phones, others are more powerful and flexible smartphones, some are small electronic tablets and tiny netbooks, etc. All of these are very convenient to use.

The Internet is a very powerful communication means and quite often, the mobile devices available in the world can employ the Internet for communication. Most of them also employ the telecom networks (such as cellular networks) for communication. Some of the mobile devices can use both the Internet as well as the telecom networks for communications.

People using mobile devices such as mobile phones often find a camera embedded in the mobile phones and take pictures. Some of them are also capable of emailing these pictures to friends. Of late, some mobile devices have become capable of displaying digital videos and movies. Some of them are also able to capture small digital video clips. Various mobile applications have been created and the demand for them is increasing. Mobile phone users, for example, can download thousands of mobile apps and often clutter up their mobile phones. Quite often, a user may download 50 or more mobile apps, each over 500K in size, each capable of being used for personal or business needs. Quite often, all the available storage as well as run-time memory on a mobile device gets used up by these mobile apps to the detriment of the users mobile experience.

Typically mobile applications are designed and coded with hard and fast behavior that cannot change. Some configuration parameters are provided to allow for minor behavior/functionality changes, such as turning off a feature or turning on a feature. These configurations seldom change once they are set. Thus, the behavior of all mobile applications are set for the features they are designed for, with some configuration flexibility. However, if a user has installed one such mobile application for collecting online data for a utility company (for the field work), such a mobile application cannot be changed into a mobile application for a dentists office, or for a real estate agent. Thus, if a user needs all three applications, then he will have to download and install three different applications onto his mobile devices. This uses up a lot of available space in storage as well as in memory during execution.

These is a need to make mobile applications available to a user without requiring the user to download and install yet another mobile application that takes an addition 500K or more storage space and clutter up the mobile device some more. There are no easy solutions available to solve this problem.

There is a need to provide custom mobile applications to users. Enterprises would like to have their own mobile applications that their employees or customers can use. However, what holds some enterprises back is the fear that these users may not want to download and install yet another application, especially if they don't use them frequently.

In general, creation of a new mobile application takes a lot of time, energy and resources. It takes a team well versed in software development and testing. It takes a team that has access to and mastery of new technology. It takes PCs, servers, code management systems, simulators integrated development environments (IDE), etc. Thus, only a few large corporations have the people and resources to develop mobile apps for their use. Small stores, small companies, and individual users do not have access to such teams of developers and to the needed resources and environment to create and deploy such systems. There is a need to make creation and deployment of mobile applications easy, inexpensive and less resource intensive and less time consuming.

In view of the foregoing considerations, it is clear that there is a need for an improved system and method that is capable of facilitating creation and deployment of mobile applications.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of the system for creating and deploying custom mobile applications that comprises a server that stores and dispenses a plurality of mobile application behavior specification to mobile devices, wherein the server interacts with mobile devices via Internet or network.

FIG. 2 is a perspective block diagram of a network wherein a mobile client in a mobile device retrieves a mobile application behavior specification and automatically creates screens with user input prompts that a user can interact with and also provide data.

FIG. 3 is a flow chart of an exemplary operation of a system for creating and deploying custom mobile applications in a network.

FIGS. 4a and 4b are parts of an exemplary mobile application behavior specification that is associated with an exemplary farmer registration mobile application.

### DETAILED DESCRIPTION OF THE DRAWINGS

The present invention provides a system for creating and deploying custom mobile applications 105 that is easy for even an individual or small enterprise to employ, wherein the system facilitates creation of a mobile application behavior specification by a user that is easily transformed to a new custom application that can be easily deployed.

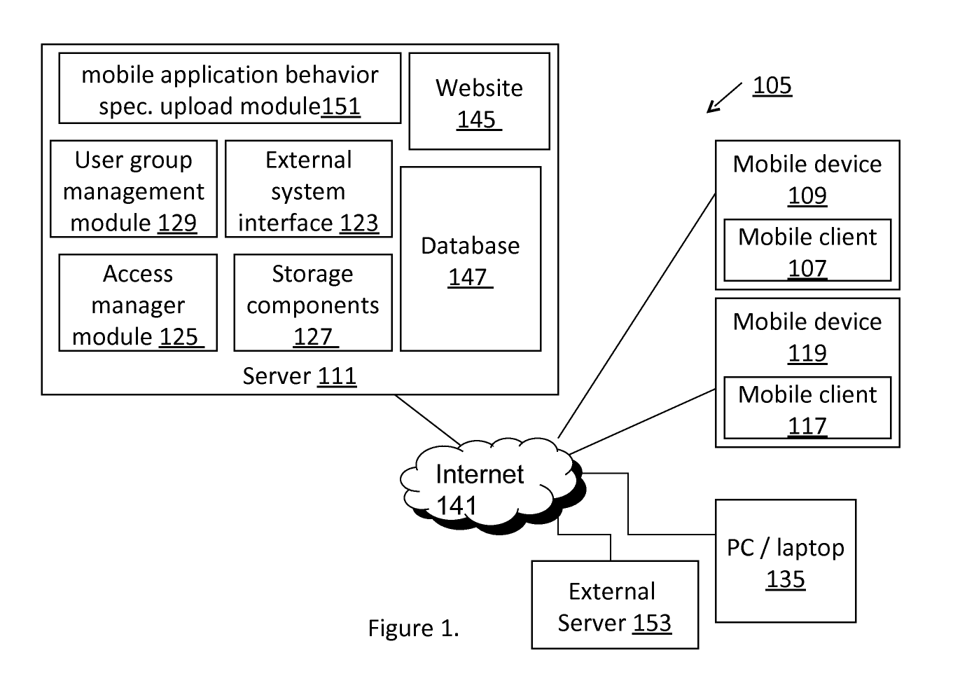

FIG. 1 is a perspective block diagram of the system for creating and deploying custom mobile applications 105 that comprises a server 111 that stores and dispenses a plurality of mobile application behavior specification to mobile devices 109, 119, wherein the server 111 interacts with mobile devices 109, 119 via Internet or network 141. The system 105 also comprises a person computer (PC)/laptop 135 that can be used by a user to create and upload one or more of the mobile application behavior specifications, and an optional external server 153. In addition, the mobile devices 109, 119 can be used by a user to create and upload one or more of the mobile application behavior specifications. Specifically, the mobile devices 109, 119 comprise a mobile client 107, 117, respectively, that facilitate retrieval of a mobile application behavior specification from the server 111 and automatically displaying one or more screens of an associated mobile application to a user, collecting data from the user, and sending it to the server 111 for storage, processing etc.

The mobile client 107 in the mobile device 109 receives a notification from the server 111, wherein the notification comprises one of a reference and a link to the a mobile application behavior specification, and, in response, the mobile client 107 retrieves the mobile application behavior specification from the server 111, processes it, automatically morphs into an associated mobile application and presents itself to a user of the mobile device 109. The user can enter data in input fields (such as text entry boxes), make selection on multiple choice prompts (inclusive or exclusive set of multiple choices are displayed), provide audio recording, provide digital photo images, record video, and send them to the server for storage associated with that mobile application (or even the external server 153).

The system for creating and deploying custom mobile applications 105 comprises a mobile application behavior specification that provides details of a plurality of screens associated with a mobile application targeted for execution on the mobile devices 109, 119 of any type, wherein each of the plurality of screens comprises a plurality of user input components and a plurality of user data display components. The system 105 comprises the server 111 that stores and dispenses the mobile application behavior specification to mobile devices 109, 119. A mobile client 107 in the mobile device 109 is capable of processing the mobile application behavior specification and is also capable of presenting each of the plurality of screens that are specified as necessary to provide the user the behavior supported/required by the associated mobile application. The mobile client 107 presents one or more of the plurality of screens to the user and solicits from the user a user response and user interactions. In general the plurality of user data display components that are spread over the plurality of screens provides the user the necessary behavior of the associated mobile application. The mobile client 107, based on the user response to solicitation of user input from one or more of the plurality of screens, or based on user interaction with at least one of the plurality of user data display components, communicates a user data to the server 111. The server 111 receives the user data and stores it. It stores in database tables that are generated for the associated mobile application using the mobile application behavior specification. In one related embodiment, the server 111 stores the user data in database tables that are generated on the fly, even without the mobile application behavior specification.

The plurality of user input components is often a collection comprising one or more user input items, wherein each of the user input items is an instance from a set comprising a textual input box, a digital photo capturing component that employs a digital camera on the mobile device, an audio recording component that employs a microphone on the mobile device, a spinner component that allows a user to select one choice from a collection of choices, a radio button selection component and a video capture component. The use of other types of user input components are also contemplated. In general, the user is expected to interact, i.e. with the user input components by providing appropriate inputs, such as providing textual data entered using the keyboard of the mobile device 109 for textual input components, capturing (recording) audio for voice input components, and capturing a digital photo (by taking a photo using the camera circuitry of the mobile device 109) using the digital photo capturing component, etc.

The user data display components is a collection comprising one or more display items, wherein each of the display items is an instance from a set of display items comprising a textual display component, an image display component, an audio recording/playback component, a table display component, a button display component, a map display component, a GPS coordinates display component and a screen navigation component for navigating between the plurality of screens. For example, the textual display component may display a welcome message in 3 Dimensional text or flashing text, another textual display component may display a question or prompt to the user in plain text, etc. Similarly, an image display component may display a logo of a company (disseminating the mobile application). Additionally, a map display component may display an image (representing a map) in which a user location is selectable by a user (on the map). The screen navigation component may be used to provide the user some control over screen flow, i.e. provide the user a degree of control over screen navigation. In some embodiment, screen navigation is based on user input(s) to a current screen, i.e. data entered by a user or selections (such as in drop down lists or multiple selection choices) made by a user are used to determine navigation between the plurality of screens of a mobile application. The mobile application behavior specification provides information that helps the mobile client 107 determine navigation between screens based on user data or user selections.

The server 111, based on the mobile application behavior specification, creates storage components 127 for a database 147 in the server 111, and stores the received user data in the database 147. The storage components, in one embodiment, are java-based code capable of storing user data in tables in the database 147, or in a file system maintained by the server 111, or in the external server 153. In one embodiment, the storage components and other server-side artifacts automatically created from the mobile application behavior specification includes JAVA code generated for STRUTS actions, HIBERNATE layer for database operations, and tables for a relational database such as a MYSQL database.

In general, the server 111 stores a plurality of mobile application behavior specifications, each of the plurality of mobile application behavior specifications being used for a different mobile application by a user of the mobile device 109. A mobile application behavior specification upload module 151 in the server 111 is used to upload mobile application behavior specifications by a user, or by a external PC/laptop or by the external server 153. The server then processes these mobile application behavior specifications and creates storage components 127 as appropriate, and also creates tables and related data (such as configuration, preferences, control blocks, etc.) in the database 147.

The mobile client 107 in the mobile device 109 presents each of the plurality of mobile application behavior specifications, as required, as a different and appropriate custom mobile application with its own user specific data retrieved from the server 111 and its own server specific behavior. For example, in one mobile application targeted towards agribusiness, where farmers can be registered, the mobile application requires the user to be an agent user and the server 111 prompts the user for his agent id and password, as specified in the associated mobile application behavior specification. The server 111 also, based on the mobile application behavior specification, provides database tables in the database 147 for registration data entered by the user. It also creates an appropriate storage component to enable CRUD (creation, read, update, deletion) operations on those database tables and on related data.

The server stores a plurality of mobile application behavior specifications uploaded by a user using a website 145 associated with the server 111, or uploaded by a user employing the PC/laptop 135. Each of the plurality of mobile application behavior specifications is associated with a different mobile application and the server 111 generates appropriate database tables for the plurality of mobile application behavior specifications that are uploaded to the server 111 or created using the website 145. In one related embodiment, the server 111 automates access to the appropriate database tables from the mobile device 109, and by a webpage provided by the website 145 of the server 111, by employing an access-code generating module (not shown).

The server 111 presents to the mobile client 109 an appropriate one of the plurality of mobile application behavior specifications when requested. For example, when the user, using the mobile client 107 of the mobile device 109, selects one mobile application from a list of mobile applications presented to the user, the appropriate/associated mobile application behavior specification is given by the server 11 to the mobile client 107, which then processes it, and displays a set of screens based on the mobile application behavior specification. Similarly, if a notification is sent from the server 111 to the mobile client 107 of the mobile device 109, the mobile client wakes up the mobile client with a reference/link to the associated mobile application behavior specification, and the mobile client 107 retrieves the mobile application behavior specification from the server 111 and then presents them to the user via screens on the mobile device 109. Thus, the mobile client 107 is capable of processing and presenting an appropriate one of the plurality of mobile application behavior specifications to the user (after retrieving them from the server 111), as necessary.

In general, data entries provided by a user from screens presented to the user, by the mobile client (for a mobile application), is sent to the server 111 for storage in the database 147. In a related embodiment, after presenting a screen comprising some of the plurality of user input components as dictated by the mobile application behavior specification, the mobile client 107 collects user inputs (sometimes referred to as the user data) and communicates it to the server 111 to determine which of the plurality of screens need to be presented next to the user. Thus, the server 111 processes the user inputs provided by the mobile client (selectively stores it) and responds back with some additional data (as necessary) and an indication of which screen needs to be displayed next to the user. Often, this results in a “branch” to a next screen based on data collected from the user thus far in a user's operation of the mobile application. In another embodiment, the mobile application behavior specification also comprises one or more branch instructions. For example, the selection of a particular choice by the user from a multiple choice set (using radio buttons, for example) results in an associated branch to a next screen, wherein the mobile application behavior specification provides information on which screen to transition to when that particular choice is selected by a user.

In general, the server 111 employs the mobile application behavior specification to automatically create appropriate database tables to store the user data received from the mobile client. It also provides URLs and security information (as necessary) to send data to the external server 153.

The server 111 provides web pages to the user to facilitate the creation of the mobile application behavior specification by the user, wherein the mobile application behavior specification is then stored by the server 111 for subsequent communication to the mobile client 107, 117 as required and wherein the mobile application behavior specification is also processed by the server 111 to create appropriate storage components 127 for storage of user data. Often these webpages are provides by the website 145 associated with the server 111, although other ways to provide the web pages are also contemplated.

The mobile client 107 is ported to several different platforms, thereby making it easy for designers/developers of mobile applications to have their service/application available on several different platforms—all they have to do is focus on the user interaction features they need. For example a version of the mobile client 107 exists for the Nokia S40 series platform, another version exists for the Nokia S60 (Symbian based devices) series platform, a third version exists for the RIM Blackberry platform, a forth version exists for the iPhone platform, and a fifth one exists for the Android platform. Additional versions for a few other (less important) platforms are also available. Thus, the mobile client 107 makes mobile apps built using the mobile application behavior specification truly portable for designers and developers, and one of these mobile application behavior specifications can be executed now easily over any of the mobile platforms in the market, thus making device portability not an issue for designers/developers of mobile applications.

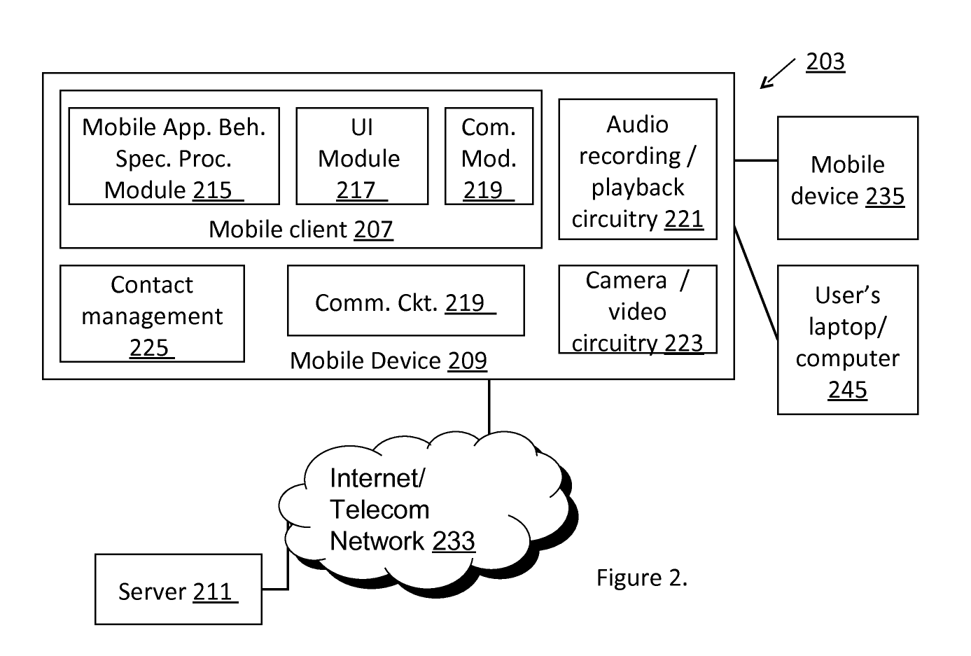

FIG. 2 is a perspective block diagram of a network 203 wherein a mobile client 207 in a mobile device 209 retrieves a mobile application behavior specification and automatically creates screens with user input prompts that a user can interact with and also provide data. The mobile client 207 in the mobile device 209 behaves as a generic mobile application, being capable of morphing into a custom application with custom behavior based on the mobile application behavior specification it retrieves from a server 211. The mobile device 209 is communicatively coupled to the server 211. The mobile client 207 processes a first mobile application behavior specification received from the server 211 and the mobile client subsequently provides user interaction components for screens that are displayed to a user to support user interaction and data entry by the user. It also provides communication features necessary for an associated first mobile application, wherein such communication can take the form of sending user data from one or more screens to the server 211 for storage or for forwarding, communication features necessary to send user data from one or more screens to a second mobile device 235, etc.

The mobile client 207 receives user inputs from a user in response to the user interaction components presented to the user. It sends the user inputs to the server 211 for storage and further processing. It morphs into a custom specific mobile application after processing the first mobile application behavior specification received from the server 211. For example, if the first mobile application behavior specification is associated with a banking mobile application, the mobile client 207 morphs into a banking mobile application—at least in terms of look and feel, custom behavior, and data collected from user, data communicated to the server 211, etc.

Subsequently, the mobile client 207 can change/morph into a different mobile application when it receives another (different) mobile application behavior specification—a second mobile application behavior specification, from the server 211. Upon receiving the second mobile application behavior specification, that is associated with a second mobile application, the mobile client 207 modifies its look and feel, the screens with prompts to the user, the behavior when data is collected, the branching between screens of the mobile application, etc. The mobile client 207 thus is capable of processing the second mobile application behavior specification received from the server 211 and the mobile client 207 subsequently provides user interaction components and communication features necessary for the second mobile application.

The mobile client 207 creates multiple screens with user interface components, display components and navigation buttons, based on the first mobile application behavior specification or the second mobile application behavior specification it receives. It also changes screens based on selection made by a user on one of the multiple screens that it displays (as part of a current mobile application), and based on the first mobile application behavior specification, it also adapts its number of screens, screen flows, data collected and data communicated. For example, it collects a user data from the multiple screens for a first mobile application that is based on a first mobile application behavior specification and communicates the user data to the server 211 for storage and further processing.

The user interface components provided by the mobile client 207 for a mobile application comprise one or more instances of items from the set (of items) comprising a textual input box, an audio recording component, a digital photo capture component, a video recording component, a multiple choice radio button group, a drop down box and a spinner. For example, any screen created by the mobile client 207 for a mobile application can contain a one or more textual input boxes, one or more buttons that facilitate capturing a digital photo from a camera/video circuitry 223 in the mobile device 209, and one or more audio recording buttons (for example a button that toggles between Record and Stop) to record user's audio input (such as voice recording) using an audio recording/playback circuitry 221.

The mobile client 207 uploads user data received from the user in the mobile device 209 to the server 211. The user data is provided by a user employing the user interface components, in one or more screens. The server 211 is used by the mobile client 207 for storage and processing of user data. For example, in one embodiment, the user data comprises a recorded audio file, a digital image file, a video stream and textual field values.

In one embodiment, the mobile client 207 receives a notification from the server 211, wherein the notification comprises one of a reference and a link to the first mobile application behavior specification, and, in response, the mobile client 207 retrieves the first mobile application behavior specification from the server 211, processes it, automatically morphs into an associated mobile application and presents itself to a user of the mobile device 209.

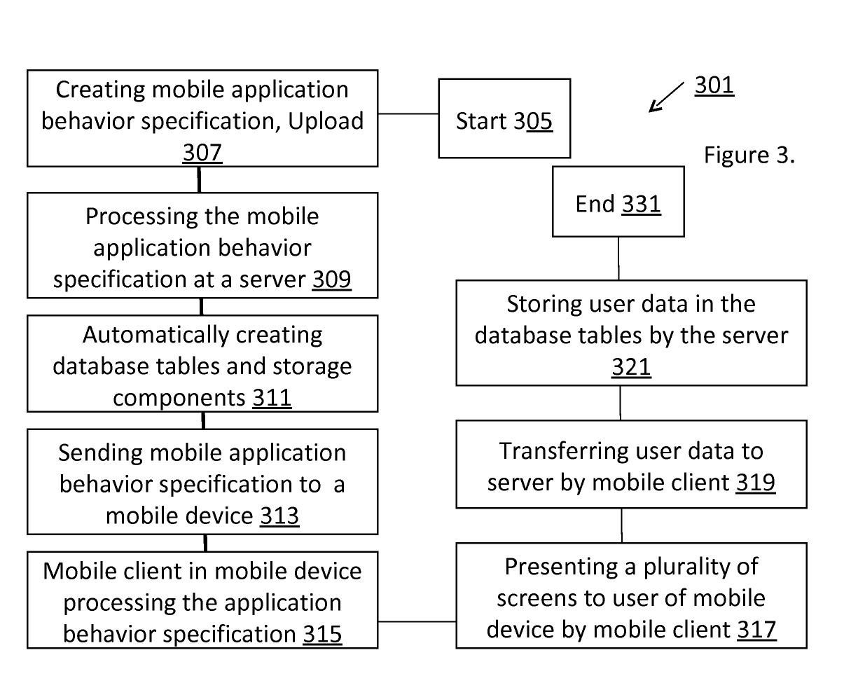

FIG. 3 is a flow chart 301 of an exemplary operation of a system for creating and deploying custom mobile applications in a network. At a start block 305, the operation starts. At a next block 307, a mobile application behavior specification for a mobile application is created. For example, a user, using the webpages provided by the website 145 in the server 111, creates the mobile application behavior specification for a mobile application, or the user, employing the PC/laptop 135, creates the mobile application behavior specification for a mobile application and uploads it to the server 111. Then, at a next block 309, the server 111 processes the mobile application behavior specification and automatically creates database 147 tables and storage components 127.

At a next block 313, the server 111 sends the mobile application behavior specification to a mobile device 109. The mobile device 109 comprises a mobile client capable of processing the mobile application behavior specification.

At a next block 315, the mobile client 107 processes the mobile application behavior specification and creates screens (one or more) as appropriate. Then, at a next block 317, the mobile client 107 presents a plurality of screens to a user of the mobile device 109 in response to receiving the mobile application behavior specification from the server 111. The plurality of screens each comprise a set of user input prompts, a set of screen navigation buttons, informative content, supplementary details to selectively guide the user in the usage of the mobile application, etc. The mobile client 107 collects a user data for the mobile application from the user of the mobile device 109. At a next block 319, it transfers the user data to the server 211. At a next block 321, the server 111 stores the user data in the database 147 tables or in external server 153. Processing then terminates at an end block 331.

In one embodiment, the set of user input prompts comprise one or more of a textual input prompt, a voice recording prompt, a digital image capture prompt, a signature entry prompt, a number prompt, a password prompt, a multiple choice selection prompt, a drop-down box selection prompt, a radio button group selection prompt, a digital pen input prompt, and a combination thereof. In a related embodiment, the set of screen navigation buttons presented to the user comprise one or more of a back button, a next screen button, a previous screen button, a first screen button, a last screen button, a top button, a bottom button, an exit button, a done button, a play button, a pause button, and a combination thereof. The mobile client 107 employs the mobile application behavior specification to determine which of the plurality of screens to navigate to, when a user navigation request is received from a user via one of the screen navigation buttons. In a related embodiment, the set of user input prompts comprises information of what the mobile client should do (what action to take, or not take) when the corresponding user input is provided by the user. For example, buttons can clearly identify, or provide a reference to, an action to be taken in response to user activating that button. Radio buttons can specify which screen (by screen numbers for example) to navigate to next after the current screen. Other forms of “branching” support for transitions between screens (or actions to be taken) based on user inputs (or lack of user inputs) to user input prompts.

In a different embodiment, mobile client 107 sends partial user data (such as those collected from one screen) to the server\determine which of the plurality of screens to navigate to, when a user navigation request is received from a user via one of the screen navigation buttons.

The informative content provided to the user, based on the mobile application behavior specification comprises one or more of a welcome text, a welcome audio message, a jingle, an advertisement, an image, a question, a user profile data or subset thereof, a result status, and a combination thereof.

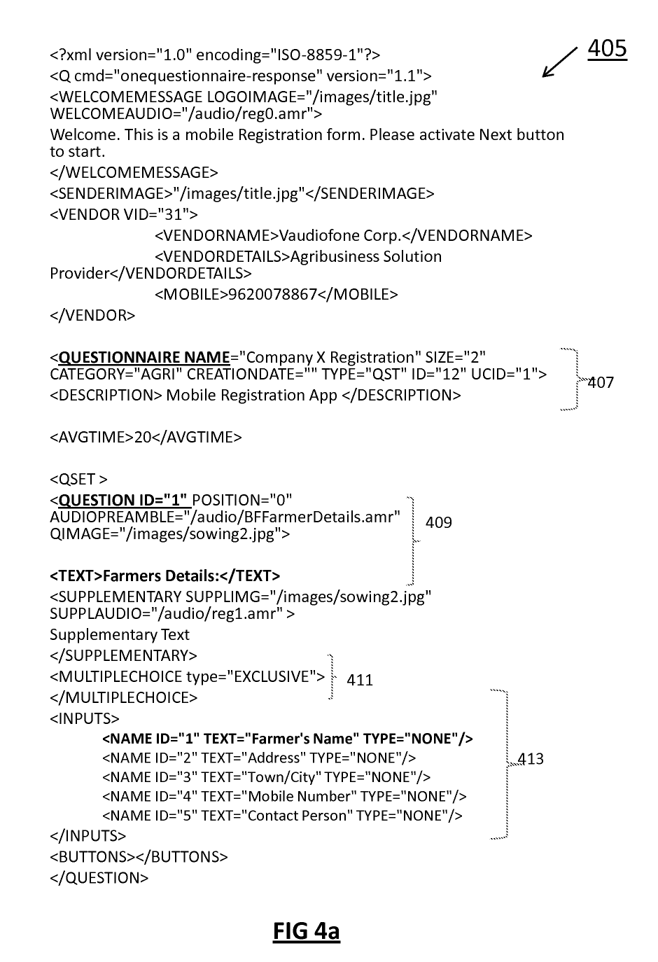

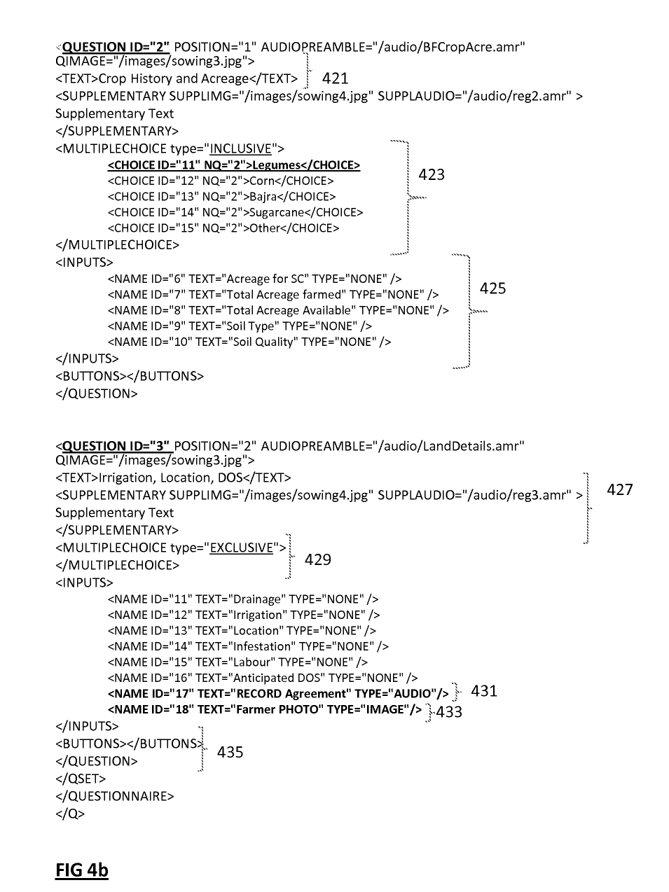

FIGS. 4a and 4b are parts of an exemplary mobile application behavior specification 405 that is associated with an exemplary farmer registration mobile application. The mobile application behavior specification 405 is an XML file one welcome screen and three screens of user data prompts. It also provides vendor information that a mobile client can display selectively, such as when a user activates an “About” button (or menu item) provided in a first welcome page presented to the user. A section 407 of the XML file provides a company name, description of the mobile app, creation date, a type associated with the mobile app, an identification for the mobile app, and a use-case id for identifying a server-side logic/behavior to influence server side processing.

A section 409 of the XML mobile application behavior specification 405 specifies some particulars of a first user data collection screen. It provides an audio preamble (link to an audio file stored at the server 111) that the mobile client retrieves and plays when the first screen is presented to the user. It also specifies a link/reference to an image that is displayed to the user in the same screen. In addition, a textual preamble for the first screen is specified. The section 409 is generally considered to be part of an informative content provided to the user, which are presented using user data display components, which is a collection comprising one or more display items. Each of the display items is an instance from a set comprising a textual display component, an image display component, an audio recording/playback component, a table display component, a button display component, a map display component, a GPS coordinates display component and a screen navigation component for navigating between the plurality of screens.

A section 411 of the XML mobile application behavior specification 405 is an exemplary multiple choice selection that the mobile client 107 presents as a set of radio buttons to the user. The user selection can be INCLUSIVE or EXCLUSIVE. In a different embodiment, instead of radio buttons, a drop down box with multiple selection capabilities is employed for the same section 411.

A section 413 of the XML mobile application behavior specification 405 is an exemplary set of user input components, comprising five text entry fields to collect a farmers contact information. The fields are for a farmers name, address, town/city, a mobile number and a contact person's name. Although a type may be specified for the fields a default of NONE is employed here, which implies generic alpha numeric textual inputs for these fields.

FIG. 4b is a continuation of the XML mobile application behavior specification 405 of FIG. 4a. A section 421 of the XML mobile application behavior specification 405 is an exemplary preamble for a second screen, with a textual preamble, an image and an audio recording that is played when the second screen is presented to the user. In addition, to the preamble (that comprises user data display components for the second screen) section 421, the second screen comprises a multiple choice selection section 423, and a user input components section 425.

A section 427 of the mobile application behavior specification 405 is a supplementary information components for the third screen of the current mobile application. It contains a link to an image to be displayed as part of the informative display, an audio recording tom be played, and supplementary text to be displayed. A video may also be displayed if necessary in a supplementary section, which is often used to provide a user more details regarding a current screen, or regarding a current mobile application or its usage.

A 429 of the mobile application behavior specification 405 is set of multiple choice selections that a user is expected to select from (no choices are presented in this example, and therefore, the multiple choices are not displayed to the user on the third screen). The third screen also comprises a set of input fields that a user interacts with as he provides data on this screen. In particular, a section 431 is of TYPE AUDIO and therefore the user is shown a toggle button with RECORD/STOP label (toggles between a RECORD label and a STOP label, for example) that is used to solicit an audio recording from the user. The recorded audio is subsequently uploaded to the server 111 and a link to it is saved.

A section 433 of the mobile application behavior specification 405 is type IMAGE and results in the display of a digital photo capture button to the user on the third screen. Specifically, a button is displayed, which when activated by the user, results in the capture of a digital photo employing the camera/video circuitry of the mobile device 109. The photo is subsequently uploaded to the server 111 and a link to it is saved.

A section 435 of the mobile application behavior specification 405 is type BUTTONS and provides a set of buttons to be used for navigating through the screens of the mobile application. Default buttons are provided by the mobile client if these buttons are not specified. In one embodiment, the default button set comprises BACK, EXIT, PREV, NEXT, etc.

As one of ordinary skill in the art will appreciate, the terms “user input components” and “UI form elements,” as may be used herein, include all types of user input means typically used in dialog boxes and UI screens where data entry by a user is facilitated. The terms “mobile application” includes downloadable lava applications, J2ME based applications, iPhone mobile apps that are coded in Object C), native mobile apps for Windows mobile (coded in C++ or other languages), mobile apps for Android platforms, etc.

Although the mobile application behavior specification is formatted as an XML document/file, other formats are contemplated, including a binary format, a zip format, etc.

Although the present invention has been described in terms of “mobile device”, it must be clear that the present invention covers PDAs, cellular phones, VOIP phones, tablets such as iPAD, and other hand held devices such as iPOD, MP3 players, DVD players, TV remotes, etc.

Although the present invention has been described in terms of user data sent from mobile client to a server, Where audio recorded on the mobile device and photo captured on the mobile device are communicated as part of the user data, it must be clear that the present invention also applies to other types of data that can be part of a user inputs provided by a user, such as text, video streams, charts, graphs, tables, html content, etc.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A system for creating and deploying custom mobile applications, comprising:
a mobile application behavior specification that comprises details of a plurality of screens associated with a mobile application targeted for execution on a mobile device of any type, wherein each of the plurality of screens comprises a plurality of user input components and a plurality of user data display components;
a server that stores and dispenses the mobile application behavior specification to a mobile device;
a mobile client in the mobile device that is capable of processing the mobile application behavior specification and capable of presenting each of the plurality of screens;
the mobile client presenting one or more of the plurality of screens to the user and soliciting a user response and user interactions with the plurality of user data display components;
the mobile client, based on the user response to solicitation of user input from one or more of the plurality of screens, or based on user interaction with at least one of the plurality of user data display components, communicates a user data to the server; and
the server receiving the user data and storing it.

2. The system of claim 1 wherein the plurality of user input components is a collection comprising one or more user input items, wherein each of the user input items is an instance from a set comprising a textual input box, a digital photo capturing component that employs a digital camera on the mobile device, an audio recording component that employs a microphone on the mobile device; a spinner component that allows a user to select one choice from a collection of choices, a radio button selection component and a video capture component.

3. The system of claim 1 wherein the user data display components is a collection comprising one or more display items, wherein each of the display items is an instance from a set of display items comprising a textual display component, an image display component, an audio recording/playback component, a table display component, a button display component, a map display component, a GPS coordinates display component and a screen navigation component for navigating between the plurality of screens.

4. The system of claim 1 wherein the server, based on the mobile application behavior specification, creates storage components for a database and stores the received user data in the database.

5. The system of claim 1 further comprising:
the server storing a plurality of mobile application behavior specifications, each of the of plurality of mobile application behavior specifications being used for a different mobile application by a user of the mobile device; and
the mobile client in the mobile device presenting each of the plurality of mobile application behavior specifications, as required, as a different and appropriate custom mobile application with its own user specific data retrieved from the server and its own server specific behavior.

6. The system of claim further comprising:
the server storing a plurality of mobile application behavior specifications uploaded, wherein each of a plurality of mobile application behavior specifications is associated with a different mobile application;
the server generating appropriate database tables for the plurality of mobile application behavior specifications;
the server automating access to the appropriate database tables from the mobile device, and by a webpage provided by the server, by employing an access-code generating module;
the server presenting to the mobile client an appropriate one of the plurality of mobile application behavior specifications when requested; and
the mobile device processing and presenting an appropriate one of the plurality of mobile application behavior specifications to the user, as necessary.

7. The system of claim 1 wherein a data entries provided by a user in response to a subset of the plurality of user input components presented to the user by the mobile client, in one of the plurality of screens, is collected by the mobile client and communicated to the server to determine which of the plurality of screens need to be presented next to the user.

8. The system of claim 1 further comprising:
the server employing the mobile application behavior specification to automatically create appropriate database tables to store the user data received from the mobile client.

9. The system of claim 1 wherein the server provides web pages to the user to facilitate the creation of the mobile application behavior specification by the user, wherein the mobile application behavior specification is then stored by the server for subsequent communication to the mobile client as required and wherein the mobile application behavior specification is also processed by the server to create appropriate storage components for storage of user data.

10. A method for creating and deploying custom mobile applications in a network, the method comprising:
creating a mobile application behavior specification for a mobile application;
processing the mobile application behavior specification at a server and automatically creating database tables and storage components;
sending the mobile application behavior specification to a mobile device comprising a mobile client capable of processing the application behavior specification;
presenting a plurality of screens to a user of the mobile device by the mobile client in response to receiving the mobile application behavior specification from the server, wherein the plurality of screens each comprise a set of user input prompts, a set of screen navigation buttons and informative content;
collecting a user data for the mobile application from a user of the mobile device by the mobile client;
transferring the user data to the server by the mobile client; and
storing the user data in the database tables by the server.

11. The method of claim 10 wherein the set of user input prompts comprise one or more of a textual input prompt, a voice recording prompt, a digital image capture prompt, a signature entry prompt, a number prompt, a password prompt, a multiple choice selection prompt, a drop-down box selection prompt, a radio button group selection prompt, a digital pen input prompt, and a combination thereof.

12. The method of claim 10 wherein a set of screen navigation buttons comprise one or more of a back button, a next screen button, a previous screen button, a first screen button, a last screen button, a top button, a bottom button, an exit button, a done button, a play button, a pause button, and a combination thereof.

13. The method of claim 10 wherein informative content comprise one or more of a welcome text, a welcome audio message, a jingle, an advertisement, an image, a question, a user profile data or subset thereof, a result status, and a combination thereof.

14. The method of claim 10 wherein the mobile client employs the mobile application behavior specification to determine which of the plurality of screens to navigate to when a user navigation request is received from a user via one of the screen navigation buttons.

15. A mobile client in a mobile device for behaving as a generic mobile application, the mobile device communicatively coupled to a server, the mobile client comprising:
the mobile client processing a first mobile application behavior specification received from the server and the mobile client subsequently providing user interaction components and communication features necessary for an associated first mobile application;
the mobile client receiving user inputs from a user in response to the user interaction components presented to the user; and
the mobile client sending the user inputs to the server for storage and further processing.

16. The mobile client of claim 15 wherein the mobile client morphing into a custom specific mobile application after processing the first mobile application behavior specification received from the server.

17. The mobile client of claim 15 further comprising:
the mobile client receiving a second mobile application behavior specification, associated with a second mobile application, from the server; and
the mobile client processing the second mobile application behavior specification received from the server and the mobile client subsequently providing user interaction components and communication features necessary for the second mobile application.

18. The mobile client of claim 15 further comprising:
the mobile client creating multiple screens with user interface components, display components and navigation buttons, based on the first mobile application behavior specification;
the mobile client changing screens based on selection made by a user on one of the multiple screens and based on the first mobile application behavior specification; and
the mobile client collecting a user data from the multiple screens and communicating the user data to the server for storage and further processing.

19. The mobile client of claim 18 further comprising:
the user interface components comprising one or more instances of items from the set comprising a textual input box, an audio recording component, a digital photo capture component, a video recording component, a multiple choice radio button group, a drop down box and a spinner; and
the mobile client uploads user data received from the user in the mobile device via the user interface components, to the server for storage and processing, wherein the user data comprises a recorded audio file, a digital image file, a video stream and textual field values.

20. The mobile client of claim 15 wherein the mobile client receives a notification from the server, wherein the notification comprises one of a reference and a link to the first mobile application behavior specification, and, in response, the mobile client retrieves the first mobile application behavior specification from the server, processes it, automatically morphs into an associated mobile application and presents itself to a user of the mobile device.
